(19) United States
(12) Patent Application Publication
(10) Pub. No.: US 2010/0123068 A1
(43) Pub. Date: May 20, 2010

(54) Mounting Bushing Unit

(75) Inventor: Suk Chul RO, Suwon-city (KR)

Correspondence Address: MORGAN, LEWIS & BOCKIUS LLP (SF), One Market, Spear Street Tower, Suite 2800, San Francisco, CA, 94105, US

(73) Assignee: HYUNDAI MOTOR COMPANY, Seoul (KR)

(21) Appl. No.: 12/512,851

(22) Filed: Jul. 30, 2009

(30) Foreign Application Priority Data
Nov. 20, 2008 (KR) 10-2008-0115635

(51) Int. Cl. F16M 13/00

(52) U.S. Cl. 248/635

(57) ABSTRACT

A mounting bushing unit may include an outer pipe and an inner pipe that is inserted into the outer pipe, wherein the outer pipe includes a first member and at least a second member disposed inside the first member and around the inner pipe, the first member being spaced apart from the second member with a predetermined distance, and wherein an insulator member is respectively filled between the first member and the second member and between the second member and the inner pipe.

### CROSS-REFERENCE TO RELATED APPLICATION

The present application claims priority to Korean Patent Application Number 10-2008-0115635 filed Nov. 20, 2008, the entire contents of which application is incorporated herein for all purposes by this reference.

### BACKGROUND OF THE INVENTION

1. Field of the Invention

The present invention relates to a mounting bushing unit, and more particularly to a mounting bushing unit for connecting a sub-frame to a vehicle body.

2. Description of Related Art

Generally, a vehicle includes a body in which plurality of members are joined to form an external shape, a suspension device, and a steering device.

A sub-frame that is mounted at a lower portion of the vehicle body supports an engine and a transmission to insure rigidity and to effectively transmit a load.

Generally, the sub-frame includes front/rear members and side members that are mounted at both sides of the front/rear members to have a quadrangular structure.

A mounting bushing unit is mounted on the end portion of the respective side members, and the sub-frame is connected to the vehicle body through the mounting bushing unit.

Here, the mounting bushing unit includes an outer pipe, an inner pipe, and an insulator that is interposed between the interior circumference of the outer pipe and the exterior circumference of the inner pipe.

The mounting bushing unit absorbs vibration that is transferred from the engine or road surface with the insulator while driving to prevent the vehicle body from vibrating.

However, the insulator may become detached from the outer pipe by the vibration that is generated in the engine or through the road surface. Accordingly, the insulator cannot function normally, and the durability and the vibration insulation capability of the mounting bushing unit are decreased such that the ride comfort of the vehicle is deteriorated.

Also, when the vehicle passes over a speed bump, there is a problem that noise is generated in the insulator that is detached from the outer pipe.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY OF THE INVENTION

Various aspects of the present invention are directed to provide a mounting bushing unit having advantages of improving durability and vibration insulation capability thereof by changing the structure of the outer pipe to increase the adhesion surface between the outer pipe and the insulator and to prevent the insulator from being separated by the vibration that is generated from the engine or the road surface.

In an aspect of the present invention, a mounting bushing unit may include an outer pipe and an inner pipe that is inserted into the outer pipe, wherein the outer pipe includes a first member and at least a second member disposed inside the first member and around the inner pipe, the first member being spaced apart from the second member with a predetermined distance, and wherein an insulator member is respectively filled between the first member and the second member and between the second member and the inner pipe, wherein the first and second members are disposed substantially in parallel to a longitudinal direction of the inner pipe.

The mounting bushing unit may further include a cap member that is coupled to the exterior circumference of the outer pipe and is mounted on one side of a sub-frame that includes front and rear members and left and right members, wherein one side of the exterior circumference of the outer pipe is fixed to the cap member, wherein the cap member includes an opening to receive the inner pipe therethrough.

The mounting bushing unit may further include a stopper plate that is mounted on a lower portion of the inner pipe to support a lower portion of the insulator member, wherein the outer pipe includes a support portion extending outwards from a bottom portion of the first member and configured and dimensioned to receive a lower portion of the cap member, wherein the stopper plate is spaced from the outer pipe with a predetermined distance and the insulator member is filled therebetween to elastically support the outer pipe, and wherein the stopper plate includes an insertion hole so that an upper portion of a mounting bolt is configured to be inserted therethrough and passes through the inner pipe.

The cap member may include an opening to receive the inner pipe therethrough and a cross section of the insertion hole of the stopper plate is smaller than a cross section of the opening of the cap member so that a lower portion of the inner pipe is supported by the stopper plate

One end portion of each of the first member and the second member may be continuously connected to each other in a circumference direction to be integrally formed, wherein the length of the second member is shorter than that of the first member at the opposite side of the connected portion of the first member and the second member.

In another aspect of the present invention, a mounting bushing unit that is mounted on an end portion of the respective side member in a sub-frame that includes front and rear members and left and right side members, that is connected to a vehicle body, and that absorbs vibration transferred from an engine and road surface, may include a cap member that is mounted on the end portion of the respective side members, an outer pipe that includes a first member, of which one side of the exterior circumference thereof is fixed to the cap member, and a second member that is disposed inside the first member, of which the exterior circumference thereof is spaced apart from the interior circumference of the first member with a predetermined gap, and of which one end portion thereof is connected to the first member, an inner pipe that is disposed at a center of the outer pipe, an insulator member that is interposed between the outer pipe and the inner pipe, and a stopper plate that is mounted on a lower portion of the inner pipe to support the lower portion of the insulator member, wherein an end portion edge of the first member is continuously connected to an end portion edge of the second member in a circumference direction, wherein at the opposite side of the connected portion of the first member and the second member, the length of the second member is shorter than that of the first member.

The insulator member may adhere to the interior circumference of the first member and the exterior circumference of the second member between the first member and the second member, and also may adhere to the exterior circumference of the inner pipe.

The insulator member may include a first insulator member that is formed between the first member and the second member, a second insulator member that is formed between the second member and the inner pipe, and a third insulator member that is formed at a portion at which the first member and the second member face each other by the second member that is shorter than the first member, wherein the first, second, and third insulator members are connected to each other to be integrally formed.

As stated above, in the mounting bushing unit according to various aspects of the present invention, the structure of the outer pipe is improved to increase the adhesion surface between the outer pipe and the insulator and to prevent the insulator from being separated by the vibration that is generated from the engine or the road surface such that the durability and the vibration insulation rate of the mounting bushing unit are improved.

Also, the mounting bushing unit prevents the insulator from being separated from the outer pipe, and also reduces the contact noise that is generated from the friction that is caused between the separated insulator and the outer pipe when excessive impact force is transferred to the vehicle such that the ride comfort is improved.

The methods and apparatuses of the present invention have other features and advantages which will be apparent from or are set forth in more detail in the accompanying drawings, which are incorporated herein, and the following Detailed Description of the Invention, which together serve to explain certain principles of the present invention.

### BRIEF DESCRIPTION OF THE DRAWINGS

FIG. 1 is a perspective view of an exemplary sub-frame that is provided with a mounting bushing unit according to the present invention.

FIG. 2 is a cross-sectional view of a mounting bushing unit according to an “A-A” line of FIG. 1.

### DETAILED DESCRIPTION OF THE INVENTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

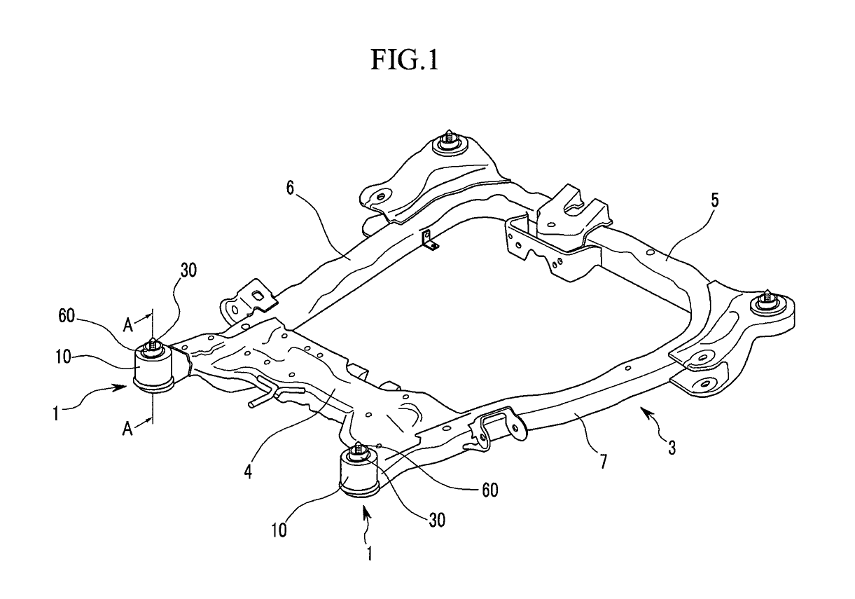

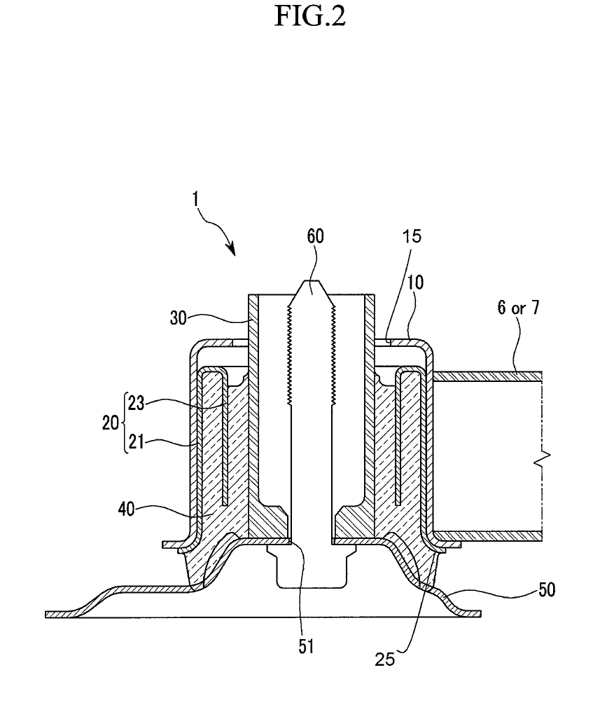

FIG. 1 is a perspective view of a sub-frame that is provided with a mounting bushing unit according to various embodiments of the present invention, and FIG. 2 is a cross-sectional view of a mounting bushing unit according to an “A-A” line of FIG. 1.

Referring to the above drawings, in the mounting bushing unit 1 according to various embodiments of the present invention, the structure of an outer pipe 20 is improved to increase the adhesion surface between the outer pipe 20 and an insulator member 40 and to prevent the adhesion surface of the insulator member 40 from being detached from the outer pipe 20 such that the durability of the mounting bushing unit 1 and the vibration insulation capability are improved.

In order to achieve this, the mounting bushing unit 1 according to various embodiments of the present invention, as shown in FIG. 1, is mounted on a sub-frame 3 that includes front and rear members 4 and 5 and left and right side members 6 and 7.

The mounting bushing unit 1 is fixed to the end portion of the respective side members 6 and 7 to be connected to the vehicle body (not illustrated), and absorbs vibration that is transferred from the engine or the road surface.

Here, the mounting bushing unit 1, as shown in FIG. 2, includes a cap member 10, the outer pipe 20, an inner pipe 30, the insulator 40, and a stopper plate 50, wherein the inner pipe 30 is inserted into the cap member 10 through an opening 15 thereof.

A space is formed inside the cap member 10 with a cylindrical shape, the exterior circumference thereof is attached to the end portion of the respective side members 6 and 7, and the outer pipe 20 is inserted into the inner space of the cap member 10.

The outer pipe 20 includes a first member 21 that forms an outside tube and a second member 23 that is inserted into the first member 21 to form an inside tube, and the interior circumference of the first member 21 and the exterior circumference of the second member 23 are disposed to have a predetermined gap from each other.

The exterior circumference of the first member 21 contacts the interior circumference of the cap member 10 to be fixed thereto, and the end portion of the first member 21 and the end portion of the second member 23 are connected to be fixed to each other.

In various embodiments of the present invention, it is desirable that the first member 21 and the second member 23 are formed by bending one plate or welding two members.

Here, the second member 23 is formed by bending the upper end of the first member 21 in a center direction thereof according to the circumference direction of the first member 21.

It is desirable that the length of the second member 23 is shorter than that of the first member 21.

The inner pipe 30 is disposed at the inside center of the outer pipe 20. That is, the inner pipe 30 is disposed at a center portion of the second member 23 with a predetermined gap therebetween.

In various embodiments, the insulator member 40 is interposed between the outer pipe 20 and the inner pipe 30.

More specifically, the insulator member 40 includes a first insulator member that is formed between the first member 21 and the second member 23, a second insulator member that is charged between the second member 23 and the inner pipe 30, and a third insulator member that is interposed between the first member 21 and the inner pipe 30.

The first, second, and third insulator members are connected to be integrally formed with each other.

Here, the insulator member 40 is disposed between the first member 21 and the second member 23 to adhere to the interior circumference of the first member 21, the exterior circumference and the interior circumference of the second member 23, and the exterior circumference of the inner pipe 30.

Further, the stopper plate 50 mounted on a lower portion of the inner pipe 30 to support the lower end surface of the insulator member 40 that is formed between the outer pipe 20 and the inner pipe 30.

An insertion hole 51 is formed in the stopper plate 50 corresponding to the inner pipe 30, and a mounting bolt 60 is inserted through the insertion hole 5 1.

The mounting bolt 60 that is inserted into the inner pipe 30 is fixed to one side of the vehicle body.

In various embodiments of the present invention, the first member 21 may include a support portion 25 extending therefrom so as to fill the insulator member 40 between the stopper plate 50 and the first member 21 of the outer pipe 20.

Referring to FIG. 2, in various embodiments of the present invention, the first member 21, the second member 23, and the inner pipe 30 are disposed in parallel with the mounting bolt 60, but the arrangement is not limited thereto.

Further, it is desirable that the first member 21, the second member 23, and the inner pipe 30 are respectively continuously formed in a circumference direction based on the center axis of the mounting bolt 60 to have a cylindrical shape.

Accordingly, when the mounting bushing unit 1 is applied according to various embodiments of the present invention, the structure of the outer pipe 20 is improved as stated above to increase the adhesion surface between the outer pipe 20 and the insulator member 40 and to prevent the insulator member 40 from being detached by the vibration that is generated from the engine or the road surface during operation such that the durability and the vibration insulation capability of the mounting bushing unit 1 are improved.

Also, the mounting bushing unit 1 prevents the insulator member 40 from being separated from the outer pipe 20, and also reduces the contact noise that is generated from the friction that is caused between the separated insulator member 40 and the outer pipe 20 when excessive impact force is transferred to the vehicle, such that the ride comfort is improved.

For convenience in explanation and accurate definition in the appended claims, the terms “upper”, “lower”, “front”, “rear”, “left”, “right”, “outer” and “inner” are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A mounting bushing unit comprising:
an outer pipe and an inner pipe that is inserted into the outer pipe;
wherein the outer pipe includes a first member and at least a second member disposed inside the first member and around the inner pipe;
the first member being spaced apart from the second member with a predetermined distance; and
wherein an insulator member is respectively filled between the first member and the second member and between the second member and the inner pipe.

2. The mounting bushing unit of claim 1, wherein the first and second members are disposed substantially in parallel to a longitudinal direction of the inner pipe.

3. The mounting bushing unit of claim 1, further comprising a cap member that is coupled to the exterior circumference of the outer pipe and is mounted on one side of a sub-frame that includes front and rear members and left and right members, wherein one side of the exterior circumference of the outer pipe is fixed to the cap member.

4. The mounting bushing unit of claim 3, wherein the cap member includes an opening to receive the inner pipe therethrough.

5. The mounting bushing unit of claim 3, further comprising a stopper plate that is mounted on a lower portion of the inner pipe to support a lower portion of the insulator member.

6. The mounting bushing unit of claim 5, wherein the outer pipe includes a support portion extending outwards from a bottom portion of the first member and configured and dimensioned to receive a lower portion of the cap member.

7. The mounting bushing unit of claim 6, wherein the stopper plate is spaced from the outer pipe with a predetermined distance and the insulator member is filled therebetween to elastically support the outer pipe.

8. The mounting bushing unit of claim 5, wherein the stopper plate includes an insertion hole so that an upper portion of a mounting bolt is configured to be inserted therethrough and passes through the inner pipe.

9. The mounting bushing unit of claim 8, wherein the cap member includes an opening to receive the inner pipe therethrough and a cross section of the insertion hole of the stopper plate is smaller than a cross section of the opening of the cap member so that a lower portion of the inner pipe is supported by the stopper plate.

10. The mounting bushing unit of claim 1, wherein one end portion of each of the first member and the second member are continuously connected to each other in a circumference direction to be integrally formed.

11. The mounting bushing unit of claim 10, wherein the length of the second member is shorter than that of the first member at the opposite side of the connected portion of the first member and the second member.

12. A mounting bushing unit that is mounted on an end portion of the respective side member in a sub-frame that includes front and rear members and left and right side members, that is connected to a vehicle body, and that absorbs vibration transferred from an engine and road surface, comprising:
a cap member that is mounted on the end portion of the respective side members;
an outer pipe that includes a first member, of which one side of the exterior circumference thereof is fixed to the cap member, and a second member that is disposed inside the first member, of which the exterior circumference thereof is spaced apart from the interior circumference of the first member with a predetermined gap, and of which one end portion thereof is connected to the first member;
an inner pipe that is disposed at a center of the outer pipe;
an insulator member that is interposed between the outer pipe and the inner pipe; and
a stopper plate that is mounted on a lower portion of the inner pipe to support the lower portion of the insulator member.

13. The mounting bushing unit of claim 12, wherein an end portion edge of the first member is continuously connected to an end portion edge of the second member in a circumference direction.

14. The mounting bushing unit of claim 13, wherein at the opposite side of the connected portion of the first member and the second member, the length of the second member is shorter than that of the first member.

15. The mounting bushing unit of claim 14, wherein the insulator member adheres to the interior circumference of the first member and the exterior circumference of the second member between the first member and the second member, and also adheres to the exterior circumference of the inner pipe.

16. The mounting bushing unit of claim 14, wherein the insulator member includes a first insulator member that is formed between the first member and the second member, a second insulator member that is formed between the second member and the inner pipe, and a third insulator member that is formed at a portion at which the first member and the second member face each other by the second member that is shorter than the first member, wherein the first, second, and third insulator members are connected to each other to be integrally formed.

17. The mounting bushing unit of claim 12, wherein the stopper plate includes a support portion extending outwards from a bottom portion of the first member and configured and dimensioned to receive a lower portion of the cap member.

18. The mounting bushing unit of claim 17, wherein the stopper plate is spaced from the outer pipe with a predetermined distance and the insulator member is filled therebetween to elastically support the outer pipe.
